(19) United States
(12) Patent Application Publication
(10) Pub. No.: US 2010/0013113 A1
(43) Pub. Date: Jan. 21, 2010

(54) METHOD FOR MANUFACTURING LENS GROUPS

(75) Inventor: KENG-MING CHANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/465,549

(22) Filed: May 13, 2009

(30) Foreign Application Priority Data
Jul. 15, 2008 (CN) 200810302750.9

(51) Int. Cl. B29D 11/00

(52) U.S. Cl. 264/1.7

(57) ABSTRACT

A method for manufacturing lens groups includes following steps. A first lens substrate and a second lens substrate are provided. A first lens array comprising spaced first lens units is formed on a surface of the first lens substrate. Each first lens unit comprises at least one positioning protrusion. A second lens array comprising spaced second lens units is formed on a surface of the second lens substrate. Each second lens unit comprises at least one positioning recess. The positioning protrusions of the first lens substrate are inserted into the respective positioning recesses of the second lens substrate to align the first lens array with the second lens array, thus forming a lens array assembly. Then the lens array assembly is cut into lens groups each including one of the first lens units and one of the second lens units.

### BACKGROUND

1. Technical Field

The present invention relates generally to a method for manufacturing lens groups.

2. Description of Related Art

At present, small scale cameras are widely used in many electronic products, such as mobile phones. Micro-lens modules comprising a plurality of aligned lenses are used in the small scale cameras. The micro-lens module is typically manufactured by a wafer level package method. The method is described in detail as follows.

In the wafer level package method, a plurality of micro-lens arrays is formed by a press molding process and then the micro-lens arrays are aligned with each other. Each micro-lens array includes a plurality of micro-lenses. The micro-lenses of each micro-lens array are arranged in rows. The lens arrays are sequentially stacked on one another in a manner that lenses of one lens array are aligned with respective lenses of other lens arrays. Then lens arrays are packaged together and cut into lens groups comprising a plurality of lenses aligned with each other.

This wafer level package method has an advantage in mass production. However, misalignment among the lenses of each lens array may inevitably occur in the wafer level package method. This may reduce the quality of the lens group.

What is needed, therefore, is a method for manufacturing lens groups to overcome the above-described deficiencies.

### BRIEF DESCRIPTION OF THE DRAWINGS

Many aspects of the present method for manufacturing lens groups can be better understood with reference to the following drawings. The components in the drawings are not necessarily drawn to scale, the emphasis instead being placed upon clearly illustrating the principles of the present method for manufacturing lens groups. Moreover, in the drawings, like reference numerals designate corresponding parts throughout the several views.

FIG. 1 is a schematic, isometric view of a micro-lens array assembly in accordance with a first exemplary embodiment.

FIG. 2 is a cross-sectional view of the micro-lens array assembly of FIG. 1, taken along line II-II.

FIG. 3 shows a first mold used in a method for manufacturing micro-lens array assembly shown in FIG. 1 in accordance with a second exemplary embodiment.

FIG. 4 is a schematic, isometric view of a first lens array molded by the first mold in FIG. 3.

FIG. 5 is a cross-sectional view of the first lens array of FIG. 4, taken along line V-V.

FIG. 6 shows another first mold used in a method for manufacturing micro-lens array assembly shown in FIG. 1.

FIG. 7 is a schematic, isometric view of a second mold used in a method of the second exemplary embodiment.

FIG. 8 is a schematic, isometric view of a second lens array molded by the second mold in FIG. 6.

FIG. 9 is a cross-sectional view of the second lens array of FIG. 8, taken along line IX-IX.

FIG. 10 is a schematic, isometric view of a first mold in accordance with a third exemplary embodiment.

FIG. 11 is a schematic, isometric view of a first lens array molded by the first mold shown in FIG. 9.

FIG. 12 is a cross-sectional view of a camera module in accordance with a fourth exemplary embodiment.

### DETAILED DESCRIPTION OF PRESENT EMBODIMENT

Reference will now be made to the drawings to describe present embodiments of micro-lens array assembly and method for manufacturing the same.

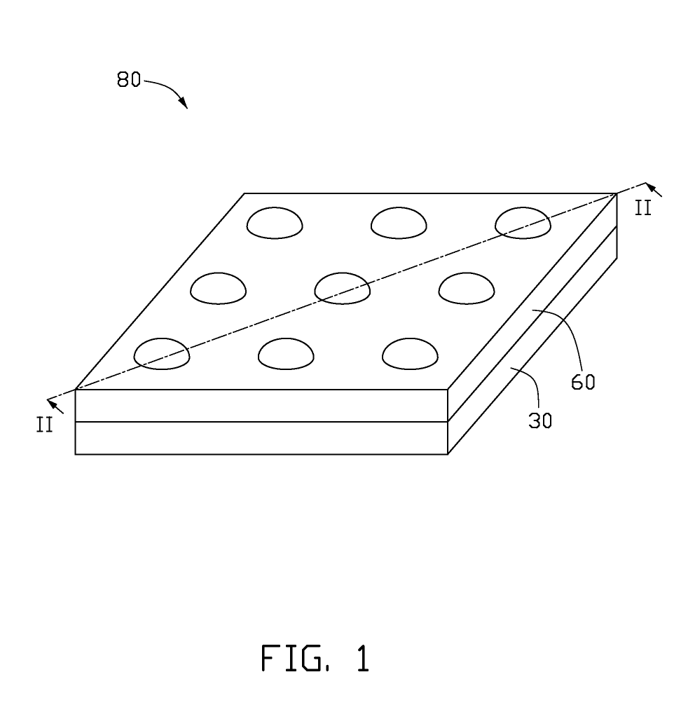

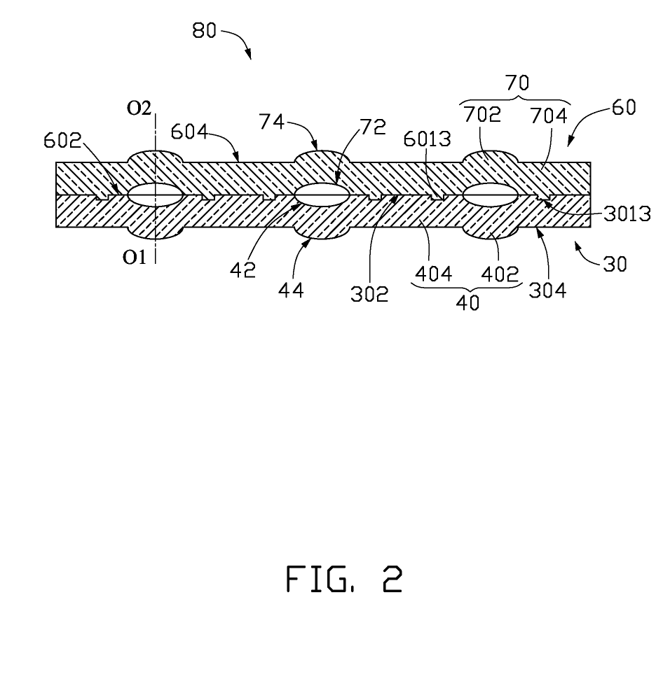

Referring to FIGS. 1 and 2, a micro-lens array assembly 80 in accordance with a first exemplary embodiment includes a first lens array 30 and a second lens array 60 assembled with the first lens array 30. The first lens array 30 includes a plurality of concave-convex micro lenses 40 and the second lens array 60 includes a plurality of concave-convex micro lenses 70. The concave-convex micro lens 40 and the concave-convex micro lens 70 can be same or different. The plurality of micro lenses 40 are arranged in a matrix in the first lens array 30 and the plurality of micro lenses 70 are arranged in a matrix in the second lens array 60.

Each micro lens 40 includes an optical portion 402 and a non-optical portion 404 surrounding the optical portion 402. Each micro lens 70 includes an optical portion 702 and a non-optical portion 704 surrounding the optical portion 702. The optical portion 402 of the lens 40 and the optical portion 702 are configured for performing transmission, refraction and reflection of light passing therethrough. The optical portion 402 of the micro lens 40 has a concave surface 42 and a convex surface 44 aligned with each other. The optical portion 702 of the micro lens 70 has a concave surface 72 and a convex surface 74 aligned with each other.

The first lens array 30 has a first surface 302 and a second surface 304 facing away from the first surface 302. The concave surfaces 42 of the micro lens 40 are formed in the first surface 302 and the convex surfaces 44 protrude from the second surface 304. The second lens array 60 has a third surface 602 and a fourth surface 604 facing away from the third surface 602. The concave surfaces 72 of the micro lens 70 are formed in the third surface 602 and the convex surfaces 74 are protruded from the fourth surface 604. Each non-optical portion 404 has two opposite surfaces (not labeled) belonging to the first surface 302 and the second surface 304 respectively. Each non-optical portion 704 has two opposite surfaces (not labeled) belonging to the first surface 602 and the second surface 604 respectively.

The optical portion 402 of the micro lens 40 has a principal axis O1. Two positioning structures are formed on each non-optical portion 404. The two positioning structures are axisymmetric about the principal axis O1. The optical portion 702 of the micro lens 70 has a principal axis O2. Two positioning structures are formed on each non-optical portion 704. The two positioning structures are axisymmetric about the principal axis O2. The two positioning structures corresponding to the first lens array 30 are two positioning recesses 3013 formed in first surface 302 of the first lens array 30. The two positioning structures corresponding to the second lens array 60 are two positioning protrusions 6013 extending from the third surface 602 of the second lens array 60. The positioning protrusions 6013 of the second lens array 60 are configured for being matingly engaged in the corresponding positioning recesses 3013 of the first lens array 30, thereby the lenses 40 of the first lens array 30 are aligned with the respective lenses 70 of the second lens array 60.

It is understood that the lenses 40 and lenses and can also be plano-concave lenses or other types. Also, the two positioning structures can also be non-axisymmetric. The number of the positioning structure corresponding to one lens 40 or one lens 70 can also be one or more than two. A shape of the positioning protrusion 6013 can be cylindrical, cuboid, pyramidal, etc.

A method for manufacturing the micro-lens array assembly 80 in accordance with a second exemplary embodiment is described as follows. The method includes following steps. Step 1: a first mold used for forming the first lens array 30 is provided. Step 2: a first light-pervious substrate is formed with a molding material on two opposite surfaces thereof and is press molded by the first mold to form the first lens array 30. Step 3: a second mold used for forming the second lens array 60 is provided. Step 4: a second light-pervious substrate is formed with a molding material on two opposite surfaces thereof and is press molded by the second mold to form the second lens array 60. Step 5: the first lens array 30 and the second lens array 60 are stacked on one another in a manner that the positioning protrusions 6013 of the second lens tray 60 are matingly engaged in the respective positioning recesses 3013 of the first lens array 30, thus aligning the micro lenses of the first and second lens arrays 30 and 60.

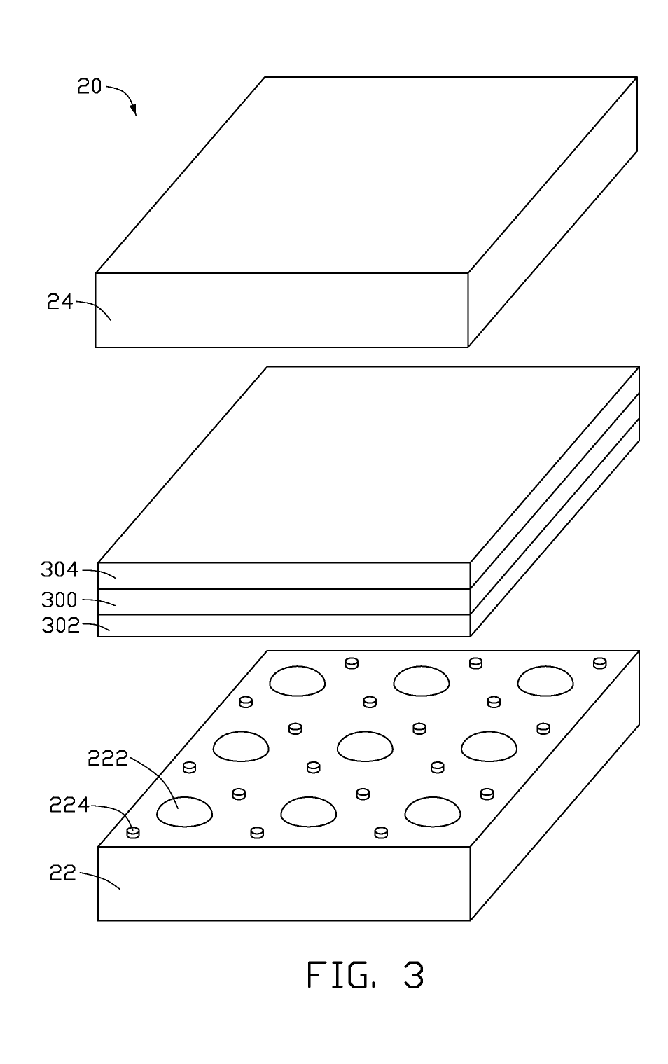

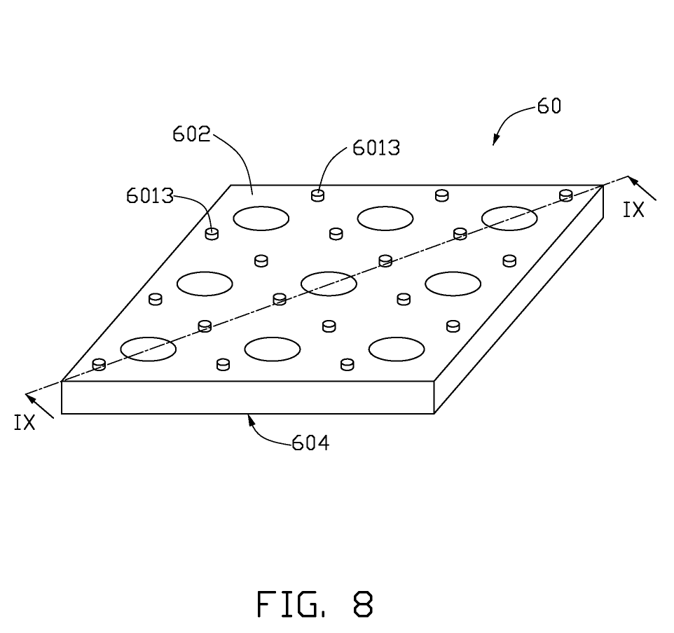

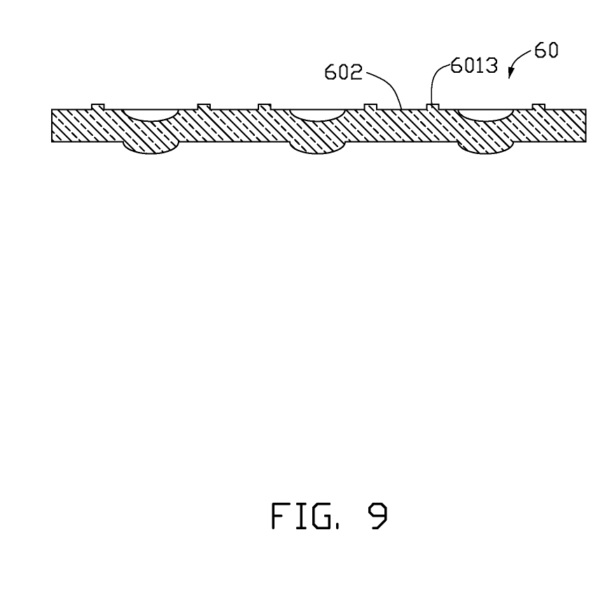

Referring to FIGS. 1 to 9, the method of manufacturing the micro-lens array assembly 80 are described in detail as follows. Referring to FIGS. 3 to 5, in step 1, the first mold 20 includes a first half mold 22 and a second half mold 24. The first half mold 22 includes a plurality of convex portions 222 for forming the concave surfaces 42, and a plurality of protrusions 224 for forming the positioning recesses 3013. The second half mold 24 includes a plurality of concave portions (not shown) for forming the convex surfaces 44. In this embodiment, the convex portions 222 and the concave portions are aspheric surfaces. The first half mold 22 and the second half mold 24 are aligned in a manner that the convex portions 222 are aligned with the respective concave portions of the second half mold.

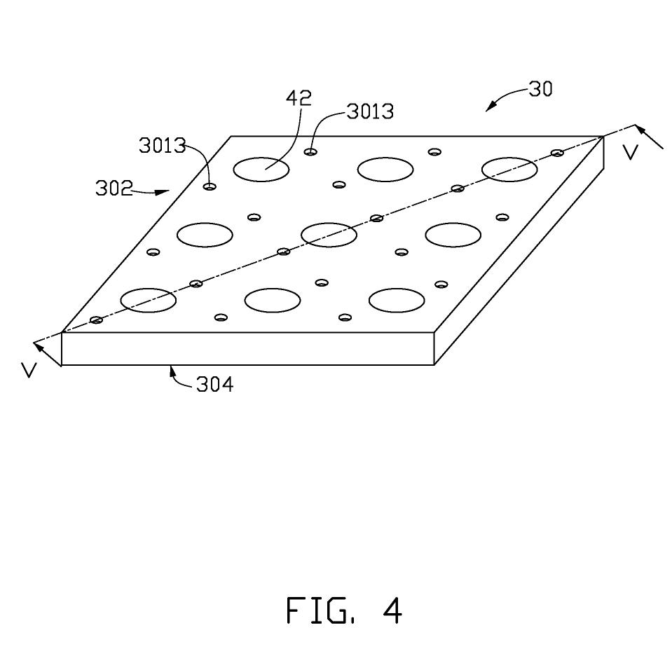

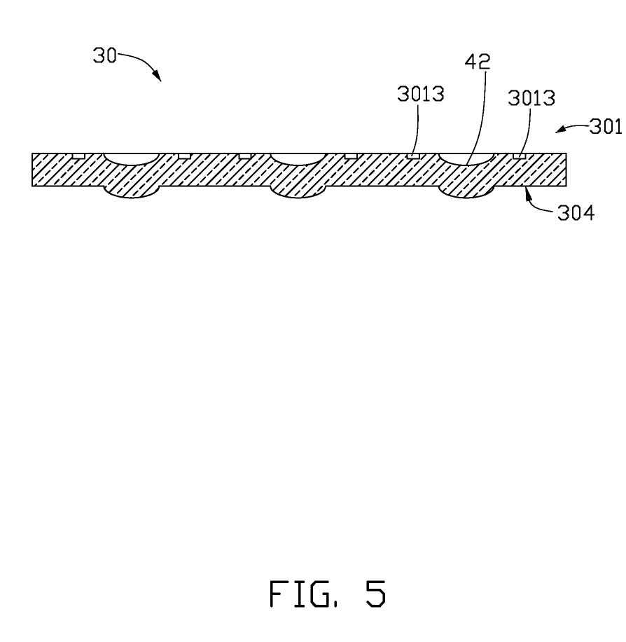

In step 2, a first light-pervious substrate 300, such as a silicon panel, is provided. A first molding material layer 302 and a second molding material layer 304 are formed on two opposite surfaces of the first light-pervious substrate 300, respectively. The first light-pervious substrate 300 formed with the first and second molding material layers 302 and 304 are positioned between the first half mold 22 and the second half mold 24. Generally, a material of the first and second lens arrays 30 and 60 can be optical plastics. In this embodiment, the first molding material layer 302 and the second molding material layer 304 are different from the material of the light-pervious substrate 300. The first and second molding material layers 302 and 304 are heated. Then the first half mold 22 is moved towards and presses firmly against the first molding material layer 302 and the second half mold 24 is moved towards and presses firmly against the first molding material layer 304. Then the light-pervious substrate 300 and the first and second molding material layers 302 and 304 are solidified by a method, such as irradiating ultraviolet light. Referring to FIGS. 4 and 5, after the press molding process, the first lens array 30 is formed.

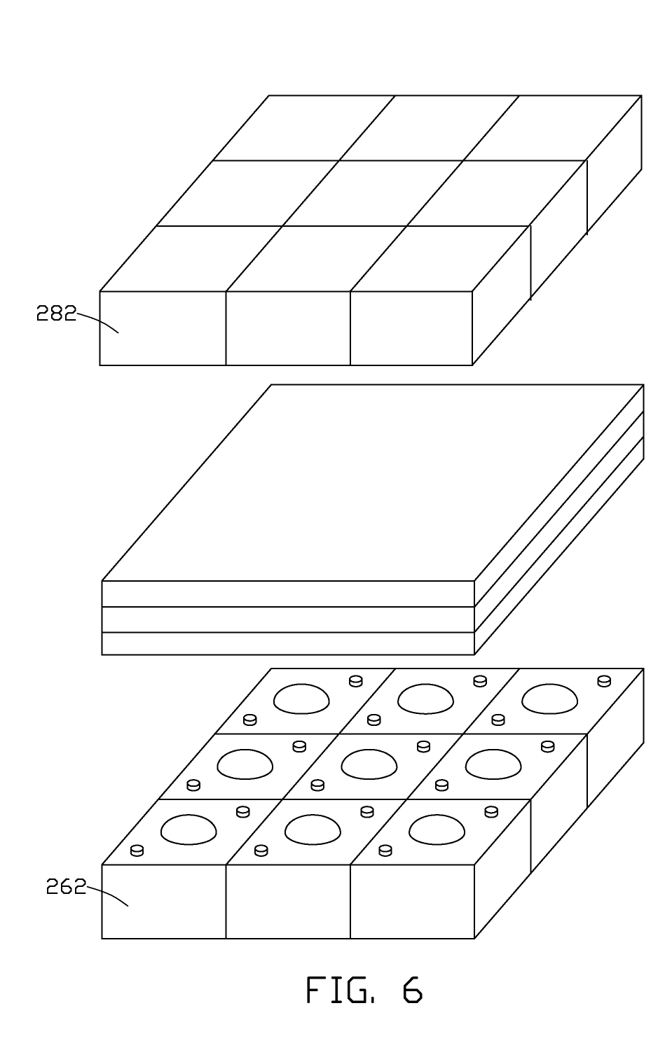

A material of the first mold 20 can be metal. The first mold 20 can be formed by a precision machining process. Referring to FIG. 6, in various alternative embodiments, the first half mold can also include a plurality of sub-molds 262, each of which corresponds to a single lens. The sub-molds 262 are identical and arranged in a matrix. In such case, the second half mold 24 can also include a plurality of sub-molds 282 aligned with the respective sub-molds 262.

When the material of the first, second molding material layers 302, 304 and the light-pervious substrate 300 are same, the first and second molding material layers 302 and 304 can be omitted. Also, the first and second molding material layers 302 and 304 can have same or different materials.

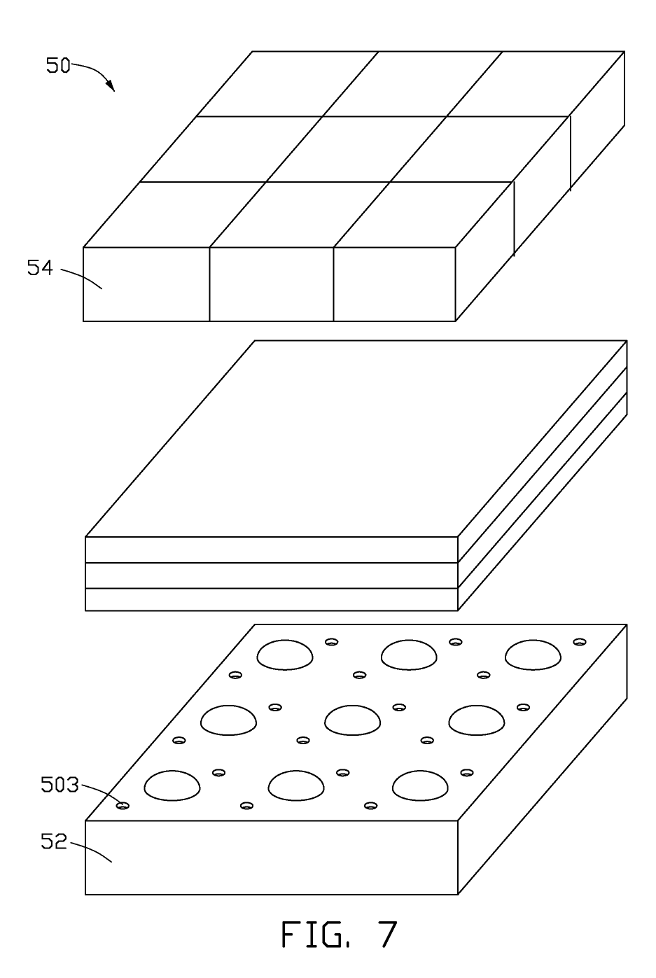

Referring to FIG. 7, in step 3, a second mold 50 used for forming the second lens array 60 is provided. The second mold 50 is similar to the first mold 20. The second mold 50 includes a third half mold 52 and a fourth half mold 54. The second mold 50 is similar to the first mold 20 and the difference is that the third half mold 52 defines a plurality of recesses 503 for forming the positioning protrusions 6013. Referring to FIGS. 7, 8 and 9, in step 4, the second lens array 60 is formed by a method similar to the step 2 using the second mold 50. The second lens array 60 and the first lens array 30 may be made of same or different materials.

Referring to FIGS. 1 and 2, in step 5, the first lens array 30 and the second array 60 are assembled together in a manner that the positioning protrusions 6013 are matingly engaged in the respective positioning recesses 3013, thus forming the lens array assembly 80. Because of cooperation of the positioning protrusions 6013 and the positioning recesses 3013, the micro lenses 40 of the first lens array 30 are aligned with the respective micro lenses 70 of the second lens array 60.

For use in cameras, the lens array assembly 80 can be cut into a plurality of lens modules, each of which includes a micro lens 40 and a micro lens 70 aligned with each other. Also, the lens array assembly 80 can be aligned with other optical element arrays, for example spacer array and infrared-cut filter array, to form a lens module array. An image sensor array may be stacked with the lens module array to form a camera module array.

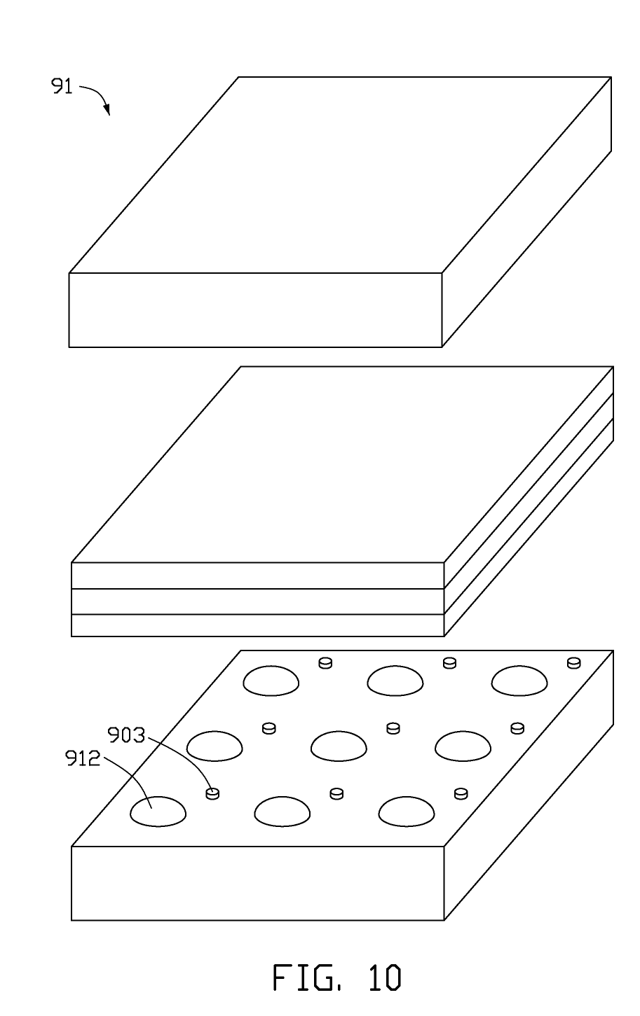

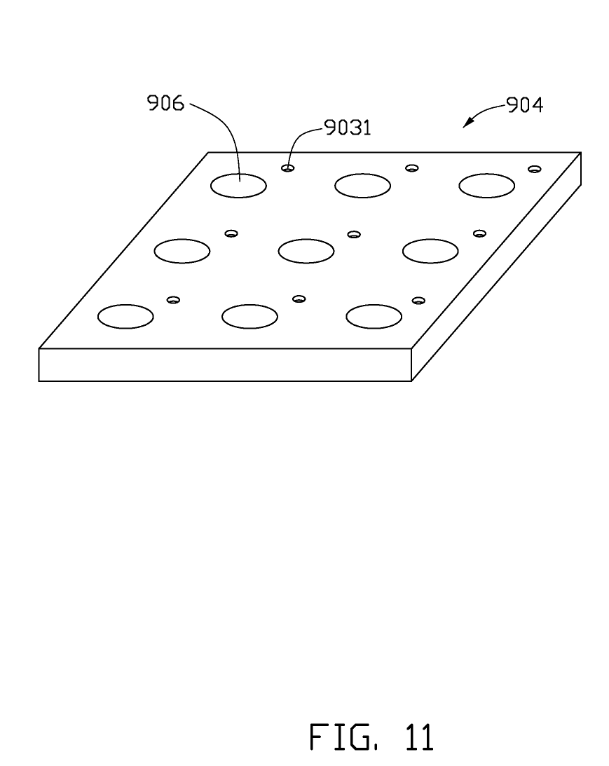

Referring to FIG. 10, a first mold 91 in accordance with a third exemplary embodiment is provided. The first mold 91 is similar to the first mold 20 in the second exemplary embodiment and the difference is that one convex portion 912 of the first half mold 910 corresponds to only one protrusion 903. Referring to FIG. 11, a first lens array 904 manufactured using the first mold 91 includes a plurality of micro lenses 906, one of which corresponds to only one positioning recess 9031 for positioning the first lens array 904 with a second lens array having corresponding positioning protrusions.

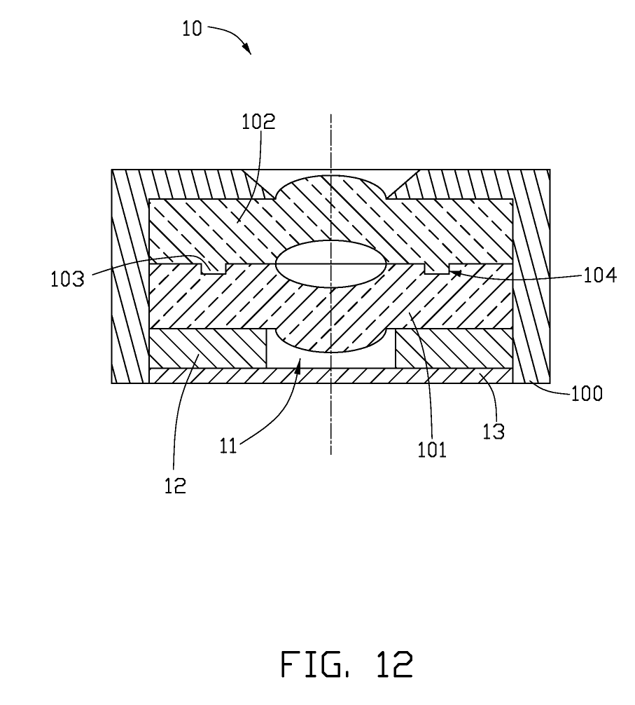

Referring to FIG. 12, a micro camera module 10 in accordance with a fourth exemplary embodiment includes a micro lens module 11, a spacer 12, an image sensor 13 and a receiving member 100. The micro lens module 11 includes a first lens 101 and a second lens 102. The first lens 101 is identical to the lens 40 of the first lens array 30 and the second lens 102 is identical to the lens 70 of the second lens array 60. Two positioning protrusions 103 of the second lens 102 are matingly engaged in respective two positioning recesses 104 such that the first lens 101 is aligned with the second lens 102. The micro lens module 11, the spacer 12 and the spacer 13 are sequentially stacked on one another and then received in the receiving member 100.

In this embodiment, the spacer 12 is configured for spacing the micro lens module 11 and the image sensor 13. In some cases, the spacer can be omitted.

The micro camera module 10 can be formed by following steps. A lens array assembly 80, a spacer array, and an image sensor array are sequentially stacked on one another to form a camera module array. Then the camera module array is cut into a plurality camera modules. The camera module generally has a cuboid shape. Furthermore, the camera module is installed in the respective receiving members 100, thus forming the micro camera module 10. Corresponding to the shape of the camera module, the receiving member 100 generally has a cuboid shape.

It is to be understood that the above-described embodiment is intended to illustrate rather than limit the invention. Variations may be made to the embodiment without departing from the spirit of the invention as claimed. The above-described embodiments are intended to illustrate the scope of the invention and not restrict the scope of the invention.

What is claimed is:

1. A method for manufacturing lens groups comprising steps:
providing a first lens substrate having a first surface and a second surface facing away from the first surface;
forming a first lens array on the first surface, the first lens array including a plurality of spaced first lens units, each of the first lens units comprising at least one positioning protrusion;
providing a second lens substrate having a third surface and a fourth surface facing away from the third surface;
forming a second lens array on the third surface, the second lens array including a plurality of spaced second lens units spatially corresponding to the first lens units, each of the second lens units comprising at least one positioning recess;
inserting the positioning protrusions of the first lens substrate into the respective positioning recesses of the second lens substrate to align the first lens array with the second lens array to form a lens array assembly; and
cutting the lens array assembly into a plurality of lens groups each including one of the first lens units and one of the second lens units.

2. The method of claim 1, wherein a material of the lens substrate includes optical plastics.

3. The method of claim 1, further comprising a step of forming a first molding material layer on the first surface and a second molding material layer on the second surface before forming the first lens array.

4. The method of claim 1, wherein the first lens array or the second lens array is formed by hot press molding.

5. The method of claim 1, wherein the step of forming the first lens array comprises:
providing a first mold half having a plurality of first molding surfaces for forming the first lens units of the first lens array, each of the first molding surfaces comprising an optical forming region for forming an optical portion and a non-optical forming region for forming a non-optical portion surrounding the optical portion, at least one recess being defined in the non-optical forming region for forming the at least one positioning protrusion;
forming a first molding material layer on the first surface of the first lens substrate;
pressing the first mold half toward the first molding material layer on the first surface of the first lens substrate to form the first lens units;
solidifying the first lens substrate with the first lens units to form the first lens array.

6. The method of claim 5, wherein the step of forming the second lens array comprise steps:
providing a second mold half having a plurality of second molding surfaces for forming a second surface of the second lens array, each of the first molding surfaces comprising an optical forming region for forming an optical portion and a non-optical forming region for forming a non-optical portion surrounding the optical portion, at least one protrusion being defined on the non-optical forming region for forming the at least one positioning recess;
forming a second molding material layer on the third surface of the second lens substrate;
pressing the second mold half toward the second molding material layer on the third surface of the second lens substrate to form the second lens units;
solidifying the second lens substrate with the second lens units using ultraviolet light.

7. The method of claim 6, wherein in the step of inserting the positioning protrusions of the first lens substrate into the respective positioning recesses of the second lens substrate, the recesses of the first molding surface are aligned with the protrusions of the second molding surface respectively.
